(19) United States
(12) Patent Application Publication
(10) Pub. No.: US 2003/0026871 A1
(43) Pub. Date: Feb. 6, 2003

(54) Methods of producing tableted gums and tableted gums so produced

(76) Inventors: Christine L. Corriveau, Orland Park, IL (US); Gwendolyn Graff, DeKalb, IL (US)

Correspondence Address: BELL, BOYD & LLOYD LLC, P. O. BOX 1135, CHICAGO, IL, 60690-1135, US

(21) Appl. No.: 09/682,176

(22) Filed: Jul. 31, 2001

(51) Int. Cl. A23G 3/30

(52) U.S. Cl. 426/5

(57) ABSTRACT

Methods of producing tableted gums and tableted gums so produced are provided. The tableted gums of the present invention include a tableting media and a gum component that includes gum chips. The gum component and tableting media are mixed and further processed to form the tableted gum wherein a substantial amount of the gum component is concentrated in a top portion of the processed tableted gum.

### BACKGROUND OF THE INVENTION

The present invention generally relates to gums. More specifically, the present invention relates to methods of producing tableted gums and tableted gums so produced.

A variety of different gums, such as chewing gums, bubble gums and products thereof, have been developed over the years to improve and enhance the quality of such products. Typically known and available gums include a variety of different shapes, sizes and colors. For example, it is generally known that individual pieces of gum can be formed into chunks, chips, sticks, tapes, shredded pieces, tabs, pellets or the like. Each of these known forms can themselves include a variety of different shapes and sizes.

With respect to gums that are formed into tablets (i.e., tableted gums), these types of gums, for example, can be made by mixing gum with a tableting powder. The mixture of gum and tableting powder is then further processed to form the tableted gum, such as commercially available tableted gums sold under the names “RAZZLES” and “BLOX”.

In addition to gum products, a variety of other consumer products are generally known and available in a tableted form. For example, tableting is widely utilized in pharmaceuticals and confections to manufacture a variety of different tableted products. In general, the tableting process of such products is similar to that of other tableting processes such as those relating to tableted gums. For example, a tableted pharmaceutical product, in general, is made by processing a mixture of a pharmaceutical agent and a pharmaceutically acceptable tableting powder in a known way.

In general, a common feature of known tableted products and processes thereof is that the mixture of the product component and tableting media is homogeneous to the extent that the size and shape of the product component and the tableting media are uniformly similar. Typically, the tableting media is in the form of a powder which is composed of a number of finely sized particles.

In this regard, the product component, such as a pharmaceutical agent or a gum agent, is generally processed prior to mixing with the tableting media such that the product component has a similar shape and size characteristic as that of the tableting media unless, of course, the product component was manufactured in such form. For example, the product component is typically ground into a powder form similar in size characteristic to the tableting powder.

One of the reasons that a homogeneous mixture of product and tableting media is preferred is that the resulting tableted product, in general, has a homogeneous make up similar to that of the pre-processed mixture. In this regard, the product component can be evenly dispersed throughout the tableted product.

However, the homogeneous mixture, particularly a powder mixture of finely sized particles, can cause the tableted product to stick or adhere to surfaces of the tableting manufacturing equipment as the tableted product is processed unless additional measures are taken to minimize the sticking properties of the powder mixture. For example, specialized equipment has been developed and utilized for processing known tableted gums to address this issue. With increased sticking properties, the tableting mixture can make it more difficult to efficiently remove the end product (i.e., the tableted product) from the process equipment. It thus can create difficulties with processing the tableted gum, cleanup of the process equipment after use and the like.

It is believed that the increased sticking is due to the small-sized particles of typical tableting mixtures, such as powder-sized particles. With smaller-sized particles, typical tableting mixtures, thus, have a high surface area which can enhance the sticking or adhering properties of the tableting mixture.

A need, therefore, exists to provide tableted gums that can be easily and readily manufactured and that can increase the level of enjoyment and excitement that one gains from chewing or blowing same.

### SUMMARY OF THE INVENTION

The present invention provides tableted gums, such as tableted bubble gum and chewing gum. The tableted gum of the present invention includes a gum component in the form of gum chips and a tableting media. The gum chips are generally larger in size than the particles of the tableting media, such as those of a tableting powder. In this regard, less force or pressure is required to process the mixture of gum chips and tableting media into a tableted gum as compared to, for example, the processing of a homogeneous tableting mixture of gum and tableting powder. Further, the larger sized gum chips tend to concentrate in a top portion of the tableted gum such that the resultant tableted gum displays the non-homogeneous characteristics of the gum chip and tableting media mixture.

To this end, in an embodiment of the present invention, a tableted gum is provided. The tableted gum includes a tableting media and a gum component including one or more gum chips.

In an embodiment, the tableting media comprises a tableting powder composed of particles that are smaller in size than the gum chips of the gum component.

In an embodiment, the gum component comprises about 40% to about 60% by weight of the tableted gum and the tableting media comprises about 40% to about 60% by weight of the tableted gum.

In an embodiment, the tableted gum comprises a top portion which contains a substantial amount of the gum chips of the gum component.

In an embodiment, the gum component is differently colored than the tableting media.

In an embodiment, the tableted gum further includes a food grade lubricant to facilitate forming the tableted gum.

In another embodiment, a gum including a mixture of gum chips and tableting media in a tableted form is provided wherein the gum chips have an average particle size greater than an average particle size of the tableting media.

In an embodiment, the average particle size of the gum chips ranges from about 0.5 mm to about 6.0 mm.

In still yet another embodiment, a method of producing a tableted gum is provided. The method includes the steps of providing a gum component; processing the gum component to form one or more gum chips; mixing the gum chips with a tableting media; and processing the mixture of gum chips and tableting media to form the tableted gum.

In an embodiment, the gum component is chilled prior to forming the gum chips.

In an embodiment, the mixture of gum chips and tableting media is punched or pressed to form the tableted gum.

It is, therefore, an advantage of the present invention to provide a tableted gum and method of producing same.

Another advantage of the present invention is to provide a tableted gum that includes a mixture of gum chips and a tableting media, such as a tableting powder.

A further advantage of the present invention is to provide a process for manufacturing a tableted gum that can readily process a mixture of gum chips and tableting media to form the tableted gum.

A still further advantage of the present invention is to provide a tableted gum that includes a non-homogeneous mixture of gum chips and tableting media due to the larger sized gum chips as compared to the particles of the tableting media.

Yet a still further advantage of the present invention is to provide a gum that creates increased levels of enjoyment and excitement during use.

Additional features and advantages of the present invention are described in, and will be apparent in, the detailed description of the presently preferred embodiments.

### DETAILED DESCRIPTION OF THE INVENTION

The present invention provides tableted gums, such as tableted bubble gums, tableted chewing gums or the like. The tableted gum of the present invention includes a gum component in the form of gum chips and a tableting media. The gum chips are generally larger in size than the particles of the tableting media, such as those of a tableting powder. This can facilitate the ease in which the tableted gums are so produced as detailed below.

Further, the larger sized gum chips tend to concentrate in a top portion of the tableted gum such that the resultant tableted gum displays the non-homogeneous characteristics of the gum chip and tableting powder mixture. This can increase and enhance levels of enjoyment and excitement during its use. In this regard, a variety of differently colored gums can be easily produced by simply varying the color of the gum component and the tableting media. For example, the gum chips of the gum component can be a chocolate color and the tableting media a cookie-dough color, thus resulting in a gum that resembles a chocolate chip cookie. In another example, the gum chips can be orange in color and the tableting media can be white thus creating large blotches of color, such as orange, at a surface of the tableted gum.

In an embodiment, the tableted gum of the present invention includes a gum component and a tableting media. The gum component includes one or more gum chips. The gum chips of the gum component are generally larger in size than the particles that compose or make-up the tableting media, such as powder-size particles of a tableting powder. In this regard, the gum chips generally have a smaller surface area than that of the particles of the tableting media.

As compared to typically known tableted gum formulations, the mixture of the gum component and tableting media of the present invention, when processed, necessarily results in less sticking or adhering of the mixture to the tableting process equipment. It is believed that this is due to the fact that the tableting mixture of the present invention contains a non-homogenous blend of tableting media and gum chips that have a larger average particle size than the average particle size of the tableting media. As compared to typical tableting mixtures which contain a homogeneously-sized mix of gum and tableting powder, the overall surface area of the tableting mixture of the present invention is smaller than that of known tableting mixtures due to the presence of the larger-sized gum chips. With a smaller surface area, less sticking of the mixture to the surface of the tableting process equipment would necessarily result upon processing the tableting mixture by punching, pressing or other like processes as detailed below.

It should be appreciated that the present invention is not limited by the size characteristics of the gum chips and the tableting media to the extent that the gum chips are larger in size than the particles of the tableting media, such as powder-sized particles of a tableting powder. In an embodiment, the average particle size of the gum chips ranges from about 0.5 millimeters (mm) to about 6.0 mm. The gum chip particles can be formed by any suitable process, preferably a chipping process, as detailed below. It should be appreciated that the particle size, unless indicated otherwise, is based on the maximum dimension of the particle. For example, the average particle size of gum chip particles which are rectangular in shape and have average dimensions of 3.2 mm×3.2 mm×1.4 mm is 3.2 mm.

The tableted gum of the present invention can include a variety of different amounts of the gum component and the tableting media. In an embodiment, the gum component includes about 40% to about 60% by weight of the tableted gum, and the tableting media includes about 40% to about 60% by weight of the tableted gum. Preferably, the gum component includes about 40% by weight of the tableted gum, and the tableting media includes about 60% by weight of the tableted gum.

It should be appreciated that the tableted gum of the present invention can include a variety of other additional ingredients in addition to the gum component and the tableting media in order to facilitate processing of the tableted gum. In an embodiment, the tableted gum includes a food grade lubricant. The food grade lubricant can include any suitably known food grade lubricant, such as magnesium stearate, calcium stearate, stearic acid, carboxy methyl cellulose, like food grade lubricants or mixtures thereof.

In an embodiment, the lubricant preferably includes magnesium stearate in an amount that is 10% or less by weight of the tableting media, preferably a tableting powder. The lubricant can be added to the tableted gum in a variety of known ways. For example, it can be separately added to the mixture of the gum component and the tableting media. Further, the lubricant can be included within the tableting media, such as commercially available tableting powders.

The tableted gum of the present invention can be produced or manufactured in a variety of suitable ways. In an embodiment, the gum component can be mixed with a tableting media in any conventional and suitable way. This mixture can then be fed into a punch machine or the like, such as a commercially available tableting machine sold under the name “STOKES”, to form the tableted gum.

For example, the mixture of gum chips and tableting media can be added to a stamping cavity or other like device. The mixture can then be punched or pressed under a suitable force or pressure to form a compacted mixture of the gum chips and tableting powder thus forming the tableted gum. As previously discussed, the amount of sticking of the tableted gum of the present invention to the tableting process equipment, such as the cavity, is less than what would necessarily occur when tableting typical mixtures of gum and tableting powder.

It has also been found that the difference in the particle size of the gum components and the tableting media results in a non-homogeneous distribution of the gum component and tableting media within the tableting mixture. Upon placing the mixture into the process cavity, the larger sized particles of the gum component (i.e., the gum chips) tend to concentrate in a top region of the cavity. Upon compaction, the gum component or at least a substantial amount of the gum component remains in a top portion of the tableted gum. In an embodiment, the gum component is differently colored or has a different color than the tableting media. In this regard, the non-homogeneous color characteristic of the tableted gum can create and enhance enjoyment and excitement during use as previously discussed. In an embodiment, the gum component and tableting media have the same or similar color.

It should be appreciated that the tableted gum can include a variety of different and suitable components. In an embodiment, the tableted gum includes a gum component and a tableting media as previously discussed. It should be appreciated that the present invention can include a sugar or a sugar free tableted gum.

The tableting media includes a variety of available and known tableting medias. Preferably, the tableting media includes a tableting powder. Typical tableting powders can include sucrose-based powders, dextrose-based powders, polyol-based powders, such as sorbitol-based powders, like tableting powders or combinations thereof. It should be appreciated that the tableting powder can include a variety of additional ingredients, such as flavors, colors, sugar and/or sugarless sweetners, additives, like ingredients or combinations thereof.

The gum component can include a variety of different components. It should be appreciated that the present invention can include any suitable gum provided that the gum can be processed into particles of requisite size. Preferably, the gum is a film forming type gum, generally referred to as bubble gum. Typically, bubble gum can be made from a standard formulation of bulk sweetener, gum base, corn syrup, softening agents, coloring agents, and flavoring agents. It should be appreciated that the gum component can be a sugar or a sugar free gum component. In an embodiment, the bubble gum is made from 60-80 percent bulk sweetener, 15-30 percent corn syrup, 1-5 percent softeners, 0.1-3 percent flavoring agents and 0.01-1 percent coloring agents.

The gum component of the present invention can be produced by conventional techniques using standard equipment. In general, the gum component is manufactured by sequentially adding various gum ingredients to a commercially available mixer known in the art. After the ingredients have been thoroughly mixed, the gum mass is discharged from the mixer and shaped into the desired form such as by rolling into sheets. Generally, the ingredients are mixed by adding the gum base to the running mixer. The base may optionally be melted in the mixer. Color and emulsifiers may also be added at this time. A softener such as glycerine may also be added at this time along with syrup and a portion of bulking agent. Further portions of the bulking agent may then be added to the mixer. A flavoring agent is typically added with the final portion of the bulking agent. The entire mixing procedure typically takes from five to twenty-five minutes, but longer mixing times may sometimes be required. Those skilled in the art will recognize that many variations of the above described procedure may be followed.

As previously discussed, the present invention is not limited by the size of gum chips within the tableting mixture of gum and tableting media provided that the gum chips have an average particle size that is greater than the average particle size of the tableting media. In this regard, any suitable process, such as chopping, extrusion, slicing, scoring or the like, can be utilized to produce the gum chips provided that the gum chips are formed into gum particles of the requisite size.

In an embodiment, the gum chips are preferably formed by any known and suitable gum chipping process, such as by the process disclosed in U.S. Pat. No. 5,318,784, the entire disclosure of which is herein incorporated by reference. In general, the gum chips can be formed by mixing gum ingredients in a conventional fashion, then sheeting, optionally scoring the gum and subsequently chipping the processed gum into chipped pieces. In an embodiment, the processed gum can be chilled or cooled at a suitable temperature prior to chipping the gum in order to facilitate such a process.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that all such changes and modifications be covered by the appended claims.

1. A tableted gum comprising:
a gum component including one or more gum chips; and
a tableting media.

2. The tableted gum of claim 1 wherein the tableting media comprises a tableting powder.

3. The tableted gum of claim 2 wherein the tableting powder is composed of particles that are smaller in size than the gum chips of the gum component.

4. The tableted gum of claim 1 wherein the gum component comprises about 40% to about 60% by weight of the tableted gum.

5. The tableted gum of claim 1 wherein the tableting media comprises about 40% to about 60% by weight of the tableted gum.

6. The tableted gum of claim 1 wherein the gum component comprises about 40% by weight of the tableted gum and the tableting media comprises about 60% by weight of the tableted gum.

7. The tableted gum of claim 6 wherein the tableted gum comprises a top portion which contains a substantial amount of the gum chips of the gum component.

8. The tableted gum of claim 7 wherein the gum chips are differently colored than the tableting powder.

9. The tableted gum of claim 1 further comprising a food grade lubricant.

10. The tableted gum of claim 9 wherein the food grade lubricant is selected from the group consisting of magnesium stearate, calcium stearate, stearic acid, carboxy methyl cellulose and mixtures thereof.

11. The tableted gum of claim 1 wherein the tableted gum comprises a sugar tableted gum or a sugar free tableted gum.

12. A gum comprising a mixture of gum chips and tableting media in a tableted form wherein the gum chips have an average particle size greater than an average particle size of the tableting media.

13. The gum of claim 12 wherein the average particle size of the gum chips ranges from about 0.5 mm to about 6.0 mm.

14. The gum of claim 12 wherein the gum chips comprise about 40% to about 60% by weight of the tableted gum and the tableting media comprises about 40% to about 60% by weight of the tableted gum.

15. A method of producing a tableted gum comprising the steps of:
providing a gum component;
processing the gum component to form one or more gum chips;
mixing the gum chips with a tableting media; and
processing the mixture of gum chips and tableting media to form the tableted gum.

16. The method of claim 15 wherein the gum component is chilled prior to forming the gum chips.

17. The method of claim 15 wherein the mixture of gum chips and tableting media is punched or pressed to form the tableted gum.

18. The method of claim 17 wherein the tableted gum comprises a top portion that is concentrated with the gum chips of the gum component.

19. The method of claim 18 wherein the gum component comprises a different color than the tableting media.

20. The method of claim 18 wherein the gum component and the tableting media have a same or similar color.

21. The method of claim 15 wherein the mixture of gum chips and tableting media includes a food grade lubricant to facilitate forming the tableted gum.

22. The method of claim 21 wherein the food grade lubricant is selected from the group consisting of magnesium stearate, calcium stearate, stearic acid, carboxy methyl cellulose and combinations thereof.

23. The method of claim 22 wherein the food grade lubricant comprises magnesium stearate ranging from about 10% or less by weight of the tableting media.

24. The method of claim 15 wherein the gum component comprises about 40% to about 60% by weight of the tableted gum and the tableting media comprises about 40% to about 60% by weight of the tableted gum.

25. The method of claim 24 wherein the gum component comprises about 40% by weight of the tableted gum and the tableting media comprises about 60% by weight of the tableted gum.

26. The method of claim 15 wherein the gum chips have an average particle size that ranges from about 0.5 mm to about 6.0 mm.
